(19) United States
(12) Patent Application Publication
(10) Pub. No.: US 2007/0159989 A1
(43) Pub. Date: Jul. 12, 2007

(54) SIP enhancements to support network-wide overload control

(75) Inventors: Matt Wu, Plano, TX (US); Hai Duong Nguyen, Plano, TX (US)

Correspondence Address: CONLEY ROSE, P.C., 5700 GRANITE PARKWAY, SUITE 330, PLANO, TX, 75024, US

(73) Assignee: Samsung Electronics Co., Ltd.

(21) Appl. No.: 11/326,854

(22) Filed: Jan. 6, 2006

(51) Int. Cl. H04L 12/16; H04L 12/66

(52) U.S. Cl. 370/260; 370/352

(57) ABSTRACT

A system for routing SIP (session initiation protocol) messages is provided. The system includes a first network element that is operable to send a message. The system also includes a second network element that is operable when overloaded and in response to receiving the message to send a reply message to the first network element indicating that the second network element is overloaded.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates to IP telephony. More specifically, but not by way of limitation, a method and system are provided that allow the proactive rerouting of messages that might otherwise be sent to an overloaded network element.

### BACKGROUND OF THE INVENTION

Internet Protocol (IP) telephony has emerged as an alternative to the traditional telephony that uses the public switched telephone network (PSTN). IP telephony uses data packet-based technologies to exchange voice, fax, video, gaming, and other data during a user session involving two or more users. The messages transmitted in an IP telephony-based message exchange do not travel in a dedicated circuit between two users, as PSTN-based calls travel. Instead, a message sent by a transmitting party is broken into data packets that may travel over different paths through a network before being reassembled and delivered to a receiving party.

The Internet Engineering Task Force has established the Session Initiation Protocol (SIP) as a standard protocol for initiating, maintaining, modifying, and terminating IP telephony calls. SIP specifies the types of messages that are sent in IP calls and the types of content that are allowed in the messages. As used herein, the term ‘call’ refers to any exchange of information over a data packet-based network including, but not limited to, voice over IP (VoIP) calls. Terms such as ‘SIP session’, ‘SIP-based message’, and the like will be used to refer to any data transfer or communication that is promoted by or initiated through SIP.

### SUMMARY OF THE INVENTION

In one embodiment, a system for routing SIP (session initiation protocol) messages is provided. The system includes a first network element that is operable to send a message. The system also includes a second network element that is operable when overloaded and in response to receiving the message to send a reply message to the first network element indicating that the second network element is overloaded.

In another embodiment, a method for routing SIP (session initiation protocol) messages is provided. The method includes sending a SIP SUBSCRIBE message from a first network element to a second network element. The SIP SUBSCRIBE message requesting a notification to the first network element when a change occurs in an overload status in the second network element. The method includes sending a SIP NOTIFY message from the second network element to the first network element when a change occurs in the overload status in the second network element.

In still other embodiments, a system for routing a data packet is disclosed. The system includes a processor that is operable for communicating via SIP (session initiation protocol). The SIP protocol includes a SIP SUBSCRIBE message containing a request to notify a sending system in the event of an overload by a receiving system. The SIP protocol further includes a SIP NOTIFY message containing a notification sent to the. sending system by the receiving system when the receiving system is overloaded.

These and other features and advantages will be more clearly understood from the following detailed description taken in conjunction with the accompanying drawings and claims.

### BRIEF DESCRIPTION OF THE DRAWINGS

For a more complete understanding of the presentation and the advantages thereof, reference is now made to the following brief description, taken in connection with the accompanying drawings in detailed description, wherein like reference numerals represent like parts.

FIG. 1 illustrates a SIP messaging system according to the prior art.

FIG. 2 illustrates a SIP messaging system according to an embodiment of the present disclosure.

FIG. 3 illustrates a SIP messaging method according to an embodiment of the present disclosure.

FIG. 4 is a block diagram of a computer system operable for some of the various embodiments of the present disclosure.

### DETAILED DESCRIPTION OF THE PREFERRED EMBODIMENTS

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

An IP call typically passes through several network elements, such as a Proxy Call Session Control Function (P-CSCF) element, a Serving Call Session Control Function (S-CSCF) element, an application server element, and other network elements well known to one of skill in the art. When a first network element wishes to communicate with a second network element, a message known as a SIP INVITE is passed from the first network element, which might be referred to as network element A, to the second network element, which might be referred to as network element B, to attempt to establish a SIP session between the two network elements. If network element B is available, network element B accepts the INVITE message and sends a 200OK message back to network element A, thus establishing the session between the network elements.

In some circumstances, network element B can become overloaded and unavailable to engage in a SIP session with network element A. Under the prior art, if network element A sent an INVITE message to network element B in such circumstances, network element B would send a message known as a 503 message back to network element A informing network element A that network element B is unavailable. Upon receiving the 503 message, network element A would attempt to send the INVITE message for that session to another network element.

If, at a later time, network element A again needed to establish a SIP session with network element B, such as for network element A's next message request, network element A would send another INVITE message to network element B. If network element B were still overloaded, network element B would again send a 503 message to network element A and network element A would again attempt to establish a session with another network element. This process might continue until network element B became available.

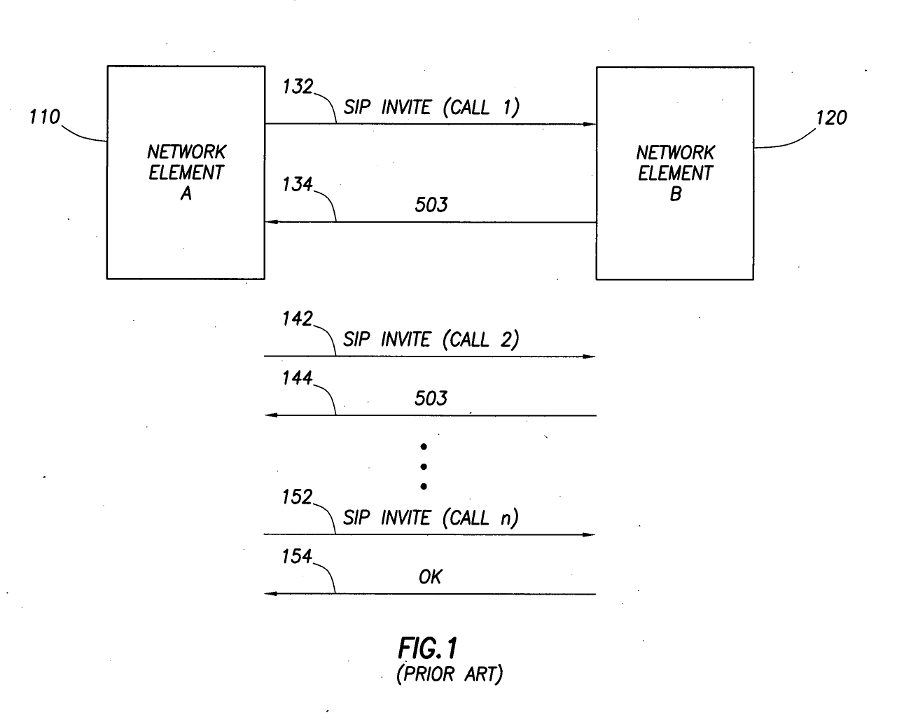

This situation is illustrated in FIG. 1. A call comes in to network element A 110 that requires network element A 110 to establish a SIP session with another network element. In this case, network element A 110 attempts to establish a session with network element B 120 by sending a first SIP INVITE 132 to network element B 120. Network element B 120 is unavailable, perhaps because it is overloaded, and sends a first 503 message 134 to network element A 110. Network element A 110 then attempts to establish a session with another network element.

If another call comes in to network element A 110, network element A 110 might again attempt to establish a session with network element B 120. To do so, network element A 110 sends a second SIP INVITE 142 to network element B 120. If network element B 120 is still unavailable, network element B 120 sends a second 503 message 144 to network element A 110 and network element A 110 again attempts to establish a session with another network element.

This process of network element A 110 sending INVITE messages to network element B 120, network element B 120 returning 503 messages to network element A 110, and network element A 110 attempting to establish a session with another network element continues until network element B 120 becomes available. At that time, if network element A 110 sent an nth INVITE message 152 to network element B 120, network element B 120 would return a 200OK message 154 to network element A 110 and a session would be established between network element A 110 and network element B 120.

This method of establishing a session between two network elements can be inefficient. Even though network element B 120 is already overloaded, it must consume additional processing resources in receiving the SIP INVITE messages from network element A 110 and sending the 503 messages back to network element A 110. Time is wasted by the repeated sending of INVITE messages to a network element that is incapable of accepting the messages.

In an embodiment of the present disclosure, a system and method are provided that allow a proactive rerouting of messages that might otherwise be sent to an overloaded network element. A first network element sends a SUBSCRIBE message to other network elements with which the first network element might attempt to establish a SIP session. The SUBSCRIBE message informs the other network elements that the first network element wishes to be notified when any of the other network elements becomes overloaded.

After receiving the SUBSCRIBE message, if any of the other network elements becomes overloaded, the overloaded network element sends the first network element a NOTIFY message informing the first network element that it is overloaded. The first network element maintains a table of network elements that are currently overloaded and the table is updated whenever the first network element receives a NOTIFY message. When the first network element wishes to establish a session with another network element, the first network element consults the table of overloaded network elements. The first network element might then send an INVITE message to a network element that is not on the table of overloaded network elements.

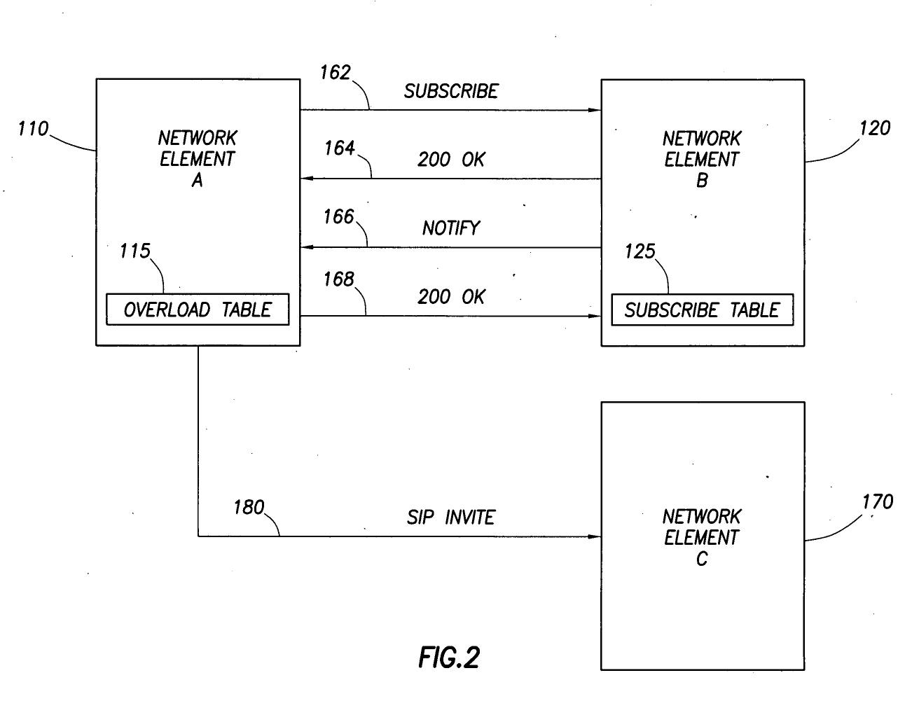

This system for rerouting messages is illustrated in FIG. 2. Network elements A and B 110, 120 respectively may be queues, servers, or other systems serving message requests from other systems and making message requests of other systems. If network element A 110 will have a need to initiate a SIP session with network element B 120, network element A 110 sends a SUBSCRIBE message 162 to network element B 120. The SUBSCRIBE message 162 informs network element B 120 that network element A 110 wishes to be notified of the overload status of network element B 120. If network element B 120 successfully receives the SUBSCRIBE message 162, network element B 120 sends a 200OK message 164 to network element A 110. While the SUBSCRIBE message 162 is shown being sent to only one network element, network element A 110 might send the SUBSCRIBE message 162 to all network elements to which it may need to send a SIP message.

In an embodiment, network element B 120 contains or has access to a table 125 listing the network elements that have subscribed to events that might occur in network element B 120. The table 125 is updated whenever network element B 120 receives a SUBSCRIBE message from another network element. For example, when network element A 110 sends the SUBSCRIBE message 162 to network element B 120, network element B 120 updates its subscription table 125 to reflect that network element B 120 should notify network element A 110 if network element B 120 becomes overloaded.

After the 200OK message 164 has been sent, network element A 110 may from time to time make message requests of network element B 120 to which network element B 120 may respond. If network element B 120 becomes overloaded, network element B 120 will send a NOTIFY message 166 to network element A 110, informing network element A 110 that network element B 120 is overloaded. While the NOTIFY message 166 is shown being sent to only one network element, network element B 120 would typically send a NOTIFY message to some or all of the network elements from which it received a SUBSCRIBE message.

In some embodiments, network element B 120 might include the intelligence to determine whether to perform priority-based throttling by notifying all or fewer than all of the requesting systems, such as network element A 110. Network element B 120 might continue to notify more and more of the requesting systems until its overload condition abates and a more manageable or efficient load is achieved. If network element A 110 successfully receives the NOTIFY message 166, network element A 110 sends a 200OK message 168 to network element B 120.

In an embodiment, network element A 110 contains or has access to a table 115 listing the network elements that are currently overloaded. The table 115 is updated whenever network element A 110 receives a message from another network element informing network element A 110 of a change in the overload status of the other network element. For example, when network element B 120 sends the NOTIFY message 166 to network element A 110, network element A 110 updates its overload table 115 to reflect that network element B 120 is overloaded.

While only an overload table 115 is shown in network element A 110 and only a subscribe table 125 is shown in network element B 120, both tables would typically be present in both network elements. The discussion herein focuses on the situation where network element A 110 is a sending element and network element B 120 is a receiving element, but it should be understood that network element A 110 can receive SIP messages from other network elements (not shown) and network element B 120 can send SIP messages to other network elements (not shown). Therefore, network element A 110 and network element B 120 would typically need to maintain both a list of network elements they have received subscription messages from and a list of network elements that are overloaded.

When calls come in to network element A 110, network element A 110 checks its table 115 of overloaded network elements. If a call would typically require network element A 110 to establish a SIP session with network element B 120 and network element B 120 is on network element A's table 115 of overloaded network elements, network element A 110 will direct some or all of the network traffic that it would otherwise send to network element B 120 to one or more other network elements. For example, network element A 110 might attempt to send network traffic to network element C 170 by sending a SIP INVITE message 180 to network element C 170.

If a new call came into network element A 110, network element A 110 would again check its table 115 of overloaded network elements, find network element B 120 in the table 115, and redirect to network element C 170 traffic that might otherwise go to network element B 120. Network element A 110 will continue to redirect traffic to other network elements in this manner until network element A 110 receives another NOTIFY message 166 from network element B 120 stating that network element B 120 is no longer overloaded.

In an embodiment, the NOTIFY message 166 can contain information regarding the level of overloading on network element B 120. Three categories of overloading levels, which might be referred to as critical, major, and minor, can be designated. In other embodiments, other numbers of overloading categories and other names for the overloading categories might be used. If network element A 110 receives a NOTIFY message 166 from network element B 120, network element A 110 updates its overload table 115 with the overload category of network element B 120.

The categories of overloading levels might be based on one or more of several different factors. In one embodiment, the occupancy level of the CPU in network element B 120 might determine the overloading category. For example, a CPU occupancy level of 90% or more could correspond to a critical overloading category, a CPU occupancy level of less than 90% but more than 60% could correspond to a major overloading category, and a CPU occupancy level of 30% to 60% could correspond to a minor overloading category. In other embodiments, other CPU occupancy levels could correspond to other overloading categories.

Other parameters that could be used to define an overload condition include memory usage, input/output activity, data error rates, software resources in use, and other parameters that will be evident to one of skill in the art. Different points within each of these parameters can correspond to different overloading categories. Combinations of two or more of these parameters might also be used to define an overload condition.

The amount of loading on a network element typically varies throughout the course of its operation. Therefore, a network element might be expected to move occasionally from one overloading category to another, from an overloaded status to a non-overloaded status, or from a non-overloaded status to an overloaded status. In an embodiment, when a change occurs in a network element's overloading category, the network element sends a NOTIFY message to the network elements that have subscribed to an overloading event. The NOTIFY message contains the new overload category. For example, if network element B 120 changed from the major overload category to the critical overload category, network element B 120 would send a NOTIFY message to network element A 110 informing network element A 110 that network element B 120 is in the critical overload category. Network element A 110 would then update its overload table 115 to reflect that network element B 120 is in the critical overload category.

In an embodiment, watermarks can be used in conjunction with the overloading categories. That is, the transition from one overloading category to another may occur over a range of numbers rather than at a single number. For example, if nominal CPU occupancy levels of 90%, 60%, and 30% correspond to critical, major, and minor overloading categories, respectively, the actual transition points from one overload category to another may occur at levels slightly above and below these nominal levels. For instance, the transition upward from a major overload to a critical overload may be defined to occur at 92% or some other level slightly above 90%. The transition downward from a critical overload to a major overload may be defined to occur at 88% or some other level slightly below 90%. By using watermarks such as these, a condition can be avoided where frequent transitions between overload categories occur.

Network element A 110 might adjust the amount of network traffic it reroutes away from network element B 120 based on the overloading category of network element B 120. For example, if the overloading on network element B 120 is critical, network element A 110 might redirect 100% of the traffic that it would otherwise send to network element B 120 to other network elements. If the overloading on network element B 120 is major, network element A 110 might redirect 70% of the traffic that it would otherwise send to network element B 120 to other network elements. If the overloading on network element B 120 is minor, network element A 110 might redirect 30% of the traffic that it would otherwise send to network element B 120 to other network elements. In other embodiments, other percentages of rerouting could be used. The percentages of rerouting might also differ when other numbers of overloading categories are used.

In an embodiment, a plurality of network elements might have the capability of performing this rerouting based on the overloading levels on the network elements in the plurality of network elements. That is, each network element in a group of network elements might be able to send SUBSCRIBE and NOTIFY messages to and receive SUBSCRIBE and NOTIFY messages from all other network elements in the group. Each network element might then be able to appropriately adjust the amount of network traffic it sends to the other network elements so that the amount of overloading on all of the network elements is minimized. In other embodiments, the network elements may communicate intelligently among one another to decide a strategy for each network element to send a certain number of messages to each of the receiving systems in the network or defined in their table, or for certain network elements to send messages to some receiving systems while other network elements send messages to other receiving systems. One of skill in the art will readily appreciate that numerous ways of managing messaging and balancing may be employed and are within the spirit and scope of the present disclosure.

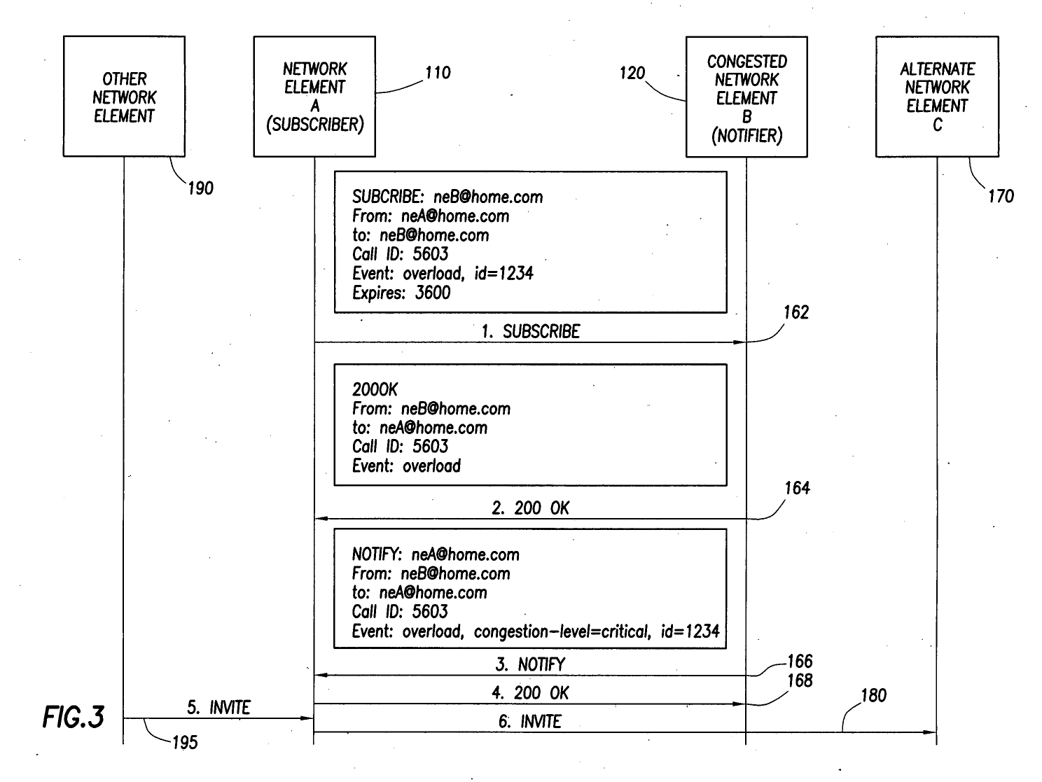

FIG. 3 illustrates an embodiment of a method for rerouting messages. Network element A 110 sends a SUBSCRIBE message 162 to network element B 120, subscribing to the notification of an overload event on network element B 120. The SUBSCRIBE message 162 might specify the network element from which the SUBSCRIBE message 162 was sent, the network element to which the SUBSCRIBE message 162 was sent, an identification code for the SUBSCRIBE message 162, the type of event about which network element A 110 wishes to be notified (in this case, an overload event), an identification code for the event, and an expiration time for the message. In other embodiments, other information may be included in the SUBSCRIBE message 162.

After successfully receiving the SUBSCRIBE message 162, network element B 120 sends a 200OK message 164 to network element A 110. The 200OK message 164 might include the network element from which the 200OK message 164 was sent, the network element to which the 200OK message 164 was sent, the identification code for the SUBSCRIBE message 162, and the type of event to which the subscription applies (an overload event). In other embodiments, other information may be included in the 200OK message 164. At this time, network element B 120 might update its table listing the network elements from which it has received SUBSCRIBE messages.

If, at some later time, network element B 120 becomes overloaded, network element B 120 will send a NOTIFY message 166 to network element A 110, informing network element A 110 that network element B 120 is overloaded. The NOTIFY message 166 might specify the network element from which the NOTIFY message 166 was sent, the network element to which the NOTIFY message 166 was sent, the identification code for the SUBSCRIBE message 162, the type of event to which the subscription applies (again, an overload event), a congestion or overload level (in this case, critical), and an identification code for the event. In other embodiments, other information may be included in the NOTIFY message 166.

Upon receiving the NOTIFY message 166, network element A 110 sends a 200OK message 168 to network element B 120. Network element A 110 also updates its table of overloaded network elements with the overloading level on network element B 120. Thereafter, if another network element 190 sends an INVITE message 195 to network element A 110, network element A 110 will check its table of overloaded network elements and discover that network element B 120 is in the table. If the INVITE message 195 would typically require network element A 110 to send an INVITE message to network element B 120, network element A 110 might instead send an INVITE message 180 to an alternate network element C 170.

While only one alternate network element C 170 is shown in FIG. 3, network element A 110 would typically reroute a portion of traffic that would otherwise be sent to network element B 120 to a plurality of alternate network elements. The proportion of traffic that is sent to network element B 120 versus being sent to the alternate network elements can depend on the level of overloading on network element B 120.

If at some later time, the level of overloading on network element B 120 changes, network element B 120 might send another NOTIFY message to network element A 110 informing network element A 110 of the new level of overloading. Network element A 110 might then update its table of overloaded network elements with the new overloading level on network element B 120 and adjust the proportion of traffic that is sent to network element B 120 versus being sent to the alternate network elements accordingly.

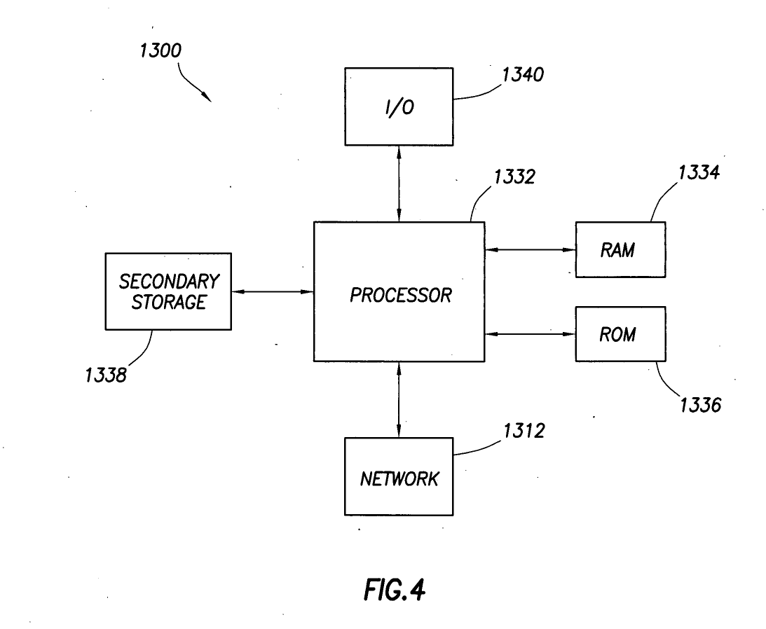

The system described above may be implemented on any general-purpose computer with sufficient processing power, memory resources, and network throughput capability to handle the necessary workload placed upon it. FIG. 4 illustrates a typical, general-purpose computer system suitable for implementing one or more embodiments disclosed herein. The computer system 1200 includes a processor 1332 (which may be referred to as a central processor unit or CPU) that is in communication with memory devices including secondary storage 1338, read only memory (ROM) 1336, random access memory (RAM) 1334, input/output (I/O) devices 1340, and network connectivity devices 1312. The processor 1332 may be implemented as one or more CPU chips.

The secondary storage 1338 is typically comprised of one or more disk drives or tape drives and is used for non-volatile storage of data and as an over-flow data storage device if RAM 1334 is not large enough to hold all working data. Secondary storage 1338 may be used to store programs that are loaded into RAM 1334 when such programs are selected for execution. The ROM 1336 is used to store instructions and perhaps data that are read during program execution. ROM 1336 is a non-volatile memory device that typically has a small memory capacity relative to the larger memory capacity of secondary storage. The RAM 1334 is used to store volatile data and perhaps to store instructions. Access to both ROM 1336 and RAM 1334 is typically faster than to secondary storage 1338.

I/O devices 1340 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1312 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 1312 may enable the processor 1332 to communicate with the Internet or one or more intranets. With such a network connection, it is contemplated that the processor 1332 might receive information from a network or might output information to a network in the course of performing the above-described method steps.

Such information, which may include data or instructions to be executed using processor 1332 for example, may be received from and outputted to the network, for example, in the form of a computer data baseband signal or signal embodied in a carrier wave. The baseband signal or signal embodied in the carrier wave generated by the network connectivity devices 1312 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1332 executes instructions, codes, computer programs, or scripts that it accesses from hard disk, floppy disk, optical disk (these various disk-based systems may all be considered secondary storage 1338), ROM 1336, RAM 1334, or the network connectivity devices 1312.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system for routing SIP (session initiation protocol) messages comprising:
a first network element operable to send a message; and
a second network element operable when overloaded and in response to receiving the message to send a reply message to the first network element indicating that the second network element is overloaded.

2. The system of claim 1, further comprising the first network element operable in response to receiving the reply message to send a message to a third network element.

3. The system of claim 1, wherein the first network element sends the message that would otherwise be sent to the second network element to a third network element.

4. The system of claim 1, wherein the message and reply message are further defined as a SIP SUBSCRIBE message and SIP NOTIFY message, respectively.

5. The system of claim 1, wherein the second network element is defined as overloaded when the second network element could achieve more efficient processing of messages by causing the first network element to route messages to other network elements.

6. The system of claim 1, further comprising the first network element maintaining information related to overloaded network elements.

7. A method for routing SIP (session initiation protocol) messages comprising:
sending a SIP SUBSCRIBE message from a first network element to a second network element, the SIP SUBSCRIBE message requesting a notification to the first network element when a change occurs in an overload status in the second network element; and
sending a SIP NOTIFY message from the second network element to the first network element when a change occurs in the overload status in the second network element.

8. The method of claim 7, further comprising when the SIP NOTIFY message informs the first network element that the second network element is overloaded, the first network element sends a third network element a SIP INVITE message since the second network element is overloaded.

9. The method of claim 8, wherein the SIP NOTIFY message specifies an overload status

10. The method of claim 7, further comprising the first network element maintaining a list of network elements that are overloaded and a category of overload for each network element on the list.

11. The method of claim 10, further comprising, when a SIP message arrives at the first network element, the first network element consults the list of network elements and sends the SIP message to a network element not on the list.

12. The method of claim 11, further comprising the first network element adjusting an amount of network traffic it routes to other network elements based on the category of overloading for each network element on the list.

13. The method of claim 12, wherein the category of overloading is based on at least one of:
an occupancy level of a CPU in the second network element;
a memory usage level in the second network element;
an input/output activity level in the second network element;
a data error rate in the second network element; and
a software resource usage level in the second network element.

14. A system for routing a data packet comprising:
a processor operable for communicating via SIP (session initiation protocol), the SIP protocol comprising:
a SIP SUBSCRIBE message containing a request to notify a sending system in the event of an overload by a receiving system, and
a SIP NOTIFY message containing a notification sent to the sending system by the receiving system when the receiving system is overloaded.

15. The system of claim 14, further comprising:
a first network element having the processor and operable to send the SIP SUBSCRIBE message;
a second network element having the processor and operable to receive the SIP SUBSCRIBE message and send the SIP NOTIFY message when the second network element is overloaded; and
a third network element having the processor and operable to receive a data packet sent from the first network element to the third network element when the second network element is overloaded.

16. The system of claim 15, wherein the first network element is operable in response to receiving the SIP NOTIFY message indicating that the second network element is overloaded to send the data packet to the third network element.

17. The system of claim 16, wherein the first network element maintains a list of network elements that are overloaded and a category of overloading for each network element on the list.

18. The system of claim 17, wherein, when a data packet arrives at the first network element, the first network element consults the list of network elements and sends the data packet to a network element not on the list.

19. The system of claim 18, wherein the data packet is transmitted under a SIP protocol.

20. The system of claim 18, wherein the first network element adjusts an amount of network traffic it routes to other network elements based on the category of overloading for each network element on the list.
